(19) United States
(12) Patent Application Publication
(10) Pub. No.: US 2004/0193561 A1
(43) Pub. Date: Sep. 30, 2004

(54) Knowledge processing system

(75) Inventor: Tadashi Ohashi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki-shi (JP)

(21) Appl. No.: 10/766,919

(22) Filed: Jan. 30, 2004

(30) Foreign Application Priority Data
Mar. 24, 2003 (JP) 2003-079466

(51) Int. Cl. G06N 5/02

(52) U.S. Cl. 706/46

(57) ABSTRACT

On the part of a designer, a super class having a code name generally indicating classes in a class group having a structured knowledge structure, is generated. By referring to the super class, the relationship in the class group can be inferred and associated by multivalued logic. If possible, a new class is generated by the inference using multivalued logic. On the part of a user, in addition to a class group indicating the knowledge structure generated on the part of the designer and the relationship among them, an inference is uniquely made by multivalued logic, the relationship among the class group is restructured, and a knowledge structure described as the relationship between classes is used.

### BACKGROUND OF THE INVENTION

1. Field of the Invention

The present invention relates to a knowledge processing system using an object-oriented language, and more specifically to a knowledge processing system using a multimedia object-oriented language.

2. Description of the Related Art

Conventionally, a designer manually draws a block diagram using stationery in developing an application, a system, etc., and draws an image using an object-oriented graphic editor function using the UML (unified modeling language), etc. on a personal computer, a work station, etc. The knowledge has been represented as accomplished knowledge using the above-mentioned drawings of the knowledge and the relationship among pieces of knowledge and the hierarchical relationship of a knowledge structure for modeling implicit knowledge (for example, personal knowledge about the real world to which a person describing the events in the real world belongs) and accomplished knowledge (knowledge actually described by a person who describes the events in the real world) of the real world and the processes (flows) and a program structure which are accumulated knowledge of the above-mentioned knowledge, the relationship among pieces of knowledge, and the hierarchical relationship of a knowledge structure. The user who refers to the knowledge and the knowledge structure has processed the knowledge by performing a creating activity in his or her brain by visually recognizing the drawings manually completed. The user has also used a personal computer, a work station, etc., to refer to or use the process (flow) of an application formed by the knowledge and the hierarchical structure, and a program structure, and make amendments as necessary, thereby fetching the implicit knowledge such as knowledge immersed in the user's brain, feelings, experience, etc. as accomplished knowledge to a knowledge database.

The conventional technology on the knowledge structure is summarized for the part of the designer and the part of the user as follows.

On the part of the designer

A designer designs a conventional program development, an application development, etc. using UML, etc., through a UML editor.

The design contents are described below.

(1) Description of a structure (use case, class, interface, component, collaboration)

(2) Description of behavior (interaction, status machine), etc.

(3) Description of a group (package)

(4) Description of a note (note)

(5) Description of a relationship (use case, class, interface, component, collaboration)

(6) Description of a diagram (views of a use case, a class, an object, a sequence, collaboration, status, an activity, a component, an arrangement), etc.

On the part of the user

The above-mentioned designed products are used by having the user manually generate them by using the application program and visually checking the designed products.

FIG. 1 shows the conventional technology.

The modeling of a knowledge structure using the UML, etc., on the part of the designer is performed by generating a class of each described event and describing the relationship among the classes.

The association among the classes can be performed based on the (1) dependence, (2) generalization, (3) relationship, (4) name, (5) role, (6), multiplicity, and (7) grouping.

In FIG. 1, the class of window maintains the relationship of dependence on the class of Event and a class of DialogBox is related to a class of Control. Since the class of CloseWindows and the class of DialogBox generally control window, they are normally included in the class of window. Therefore, DialogBox and CloseWindows are associated with the class of window in the association of generalization. The class of person is associated with the class of Company, and is associated such that person works for Company. Person and Company have a name of a person and a name of a company as instances. Furthermore, person and Company are assigned role names. In this case, the person is assigned the role name of employee, and the Company is assigned the role name of employer. Depending on the number of persons belonging to one company, multiplicity is defined. When the person described in person belongs to only one company, the multiplicity of person to Company is 1. When the number of employees of a company is 100, there are 100 classes of a person class associated with Company, and the multiplicity of Company to person is 100. Additionally, a company normally includes a plurality of departments. In this example, the class of Department describing a department is necessarily grouped in a class of Company and associated therein. This is referred to as grouping.

An example of association among classes used in designing a knowledge structure on the part of the designer is described above. On the part of the designer, the association is fully used in designing various knowledge contents. On the other hand, in the conventional technology, the user who receives the designed knowledge contents reads and understands the read knowledge contents.

In the patent document 1, in the object-oriented program such as UML, etc., the technology of automatically determining whether or not the information reflected by multimedia design information is to be extracted, thereby improving the determination precision.

In the patent document 2, in testing the result of object-oriented design using the UML, etc., the technology of supporting a simple operation and an operation having a larger number of reference items, and generating a test item such that the number of test items does not increase unnecessarily.

[Patent Document 1]

Japanese Patent Application Laid-open No. 2000-112742

[Patent Document 2]

Japanese Patent Application Laid-open No. 2001-222429

The problems with the object-oriented knowledge design using the conventional UML, etc., on the part of the designer and on the part of the user are described below.

On the part of the designer

(1) The UML is a language capable of describing the structure of knowledge, but the majority of described events in the real world is implicit knowledge, and cannot be necessarily represented in a language.

(2) The UML is a language available in visualizing a knowledge structure, but the visualizing operation is not determinate but abstract in the real world.

(3) The UML is a language for specification of knowledge contents. However, the contents of specifications are to be simple and clear, and not to be logically uncertain, but in the real world where knowledge contents are specified, a large number of uncertain elements exist.

(4) The UML is used for a concept model, but the concept itself is a personal viewpoint of a party in most cases, and the third party can easily distort it.

Relating to a designing operation, the existing tools leave all conditions of performing a designing process to a user, thereby bearing a large load on a designer.

On the part of the user

Since the existing tools leave to a user all conditions of using knowledge contents designed on the part of the designer, the load on the user is considerably large.

### SUMMARY OF THE INVENTION

The present invention aims at providing a knowledge processing system capable of reducing the load on a designer and a user, and correctly designing knowledge. Especially, the knowledge processing system is a multimedia knowledge processing system.

The knowledge processing system according to the present invention configures the structure of the knowledge relating to a designed event based on the class and the relationship between the classes, and includes a storage unit for storing in a database a super class having a name inclusively describing the class of the knowledge, the class, and the relationship between the classes, and a inference unit for detecting the class relating to the super class stored in the database, generating the relationship between the classes by the inference based on multivalued logic, and configuring the knowledge structure from the information stored in the database and the relationship between the classes obtained by the inference.

According to the present invention, a class representing the knowledge structure of a super class is provided, and classes are associated with each other in the form of determining whether or not the class relates to a super class. Furthermore, in structuring a class, in addition to the relationship between classes designed by a designer, the relationship between new classes obtained as a result of the inference by a computer can be a part of the knowledge structure.

According to another aspect of the present invention, by inference using multivalued logic, a new class is generated, a knowledge structure is represented in more detail, the portion of implicit knowledge is reduced, and the knowledge is structured using accomplished knowledge independent of the personal viewpoint of a designer, thereby notifying the user of more correct and comprehensible knowledge contents described by the knowledge structure. In this case, the user can also add a result of the inference on the part of the user to the knowledge structure in addition to the knowledge structure generated on the part of the designer.

### BRIEF DESCRIPTION OF THE DRAWINGS

FIG. 1 is an explanatory view of the conventional technology;

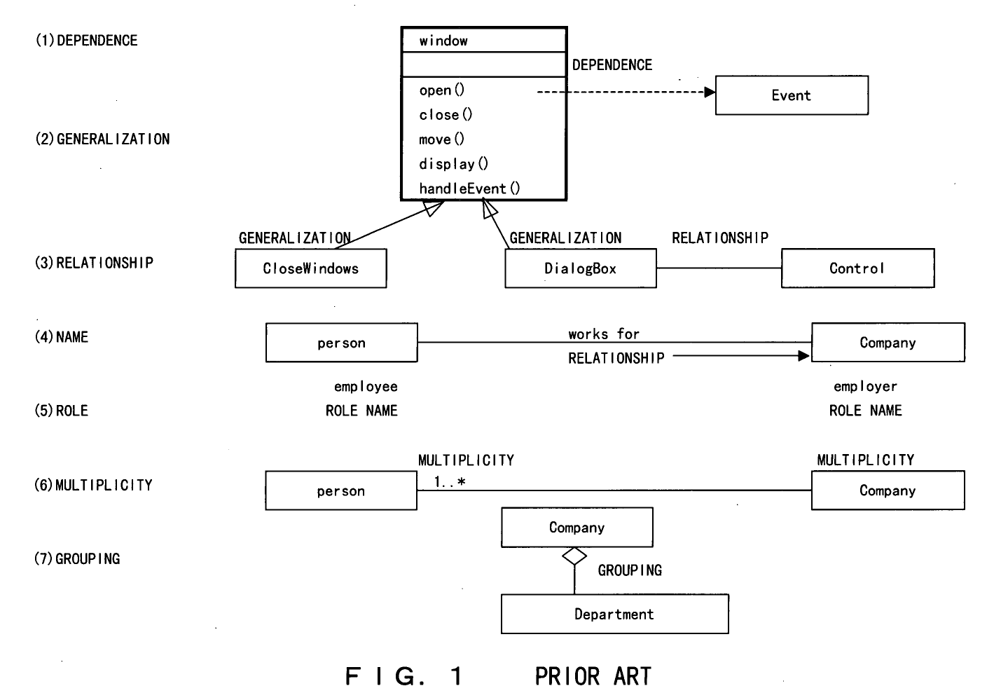

FIG. 2 is an explanatory view of the central portion according to an embodiment of the present invention;

FIG. 3 is an explanatory view (1) showing an example in which an embodiment of the present invention is practically applied;

FIG. 4 is an explanatory view (2) showing an example in which an embodiment of the present invention is practically applied;

FIG. 5 is an explanatory view (3) showing an example in which an embodiment of the present invention is practically applied;

FIG. 6 is an explanatory view (4) showing an example in which an embodiment of the present invention is practically applied;

FIG. 7 is an explanatory view (5) showing an example in which an embodiment of the present invention is practically applied;

FIG. 8 is an explanatory view (6) showing an example in which an embodiment of the present invention is practically applied;

FIG. 9 is an explanatory view (7) showing an example in which an embodiment of the present invention is practically applied;

FIG. 10 is an explanatory view (1) showing the relationship between a knowledge structure and a class;

FIG. 11 is an explanatory view (2) showing the relationship between a knowledge structure and a class;

FIG. 12 is an explanatory view (3) showing the relationship between a knowledge structure and a class;

FIG. 13 is an explanatory view (4) showing the relationship between a knowledge structure and a class;

### DESCRIPTION OF THE PREFERRED EMBODIMENTS

In the present invention, a class (super class) which has a name such as a code name in a knowledge database or in a Web space (for example, a name of a development code name uniquely assigned to the developing project when a knowledge structure is designed in a developing project) and corresponds to an inclusive and broader concept is processed as the knowledge having the function of structuring knowledge indicated by the conventional technology, the relationship between pieces of knowledge weighted when a designer performs a designing process and a user uses a designed product, the hierarchical relationship, etc., are automatically and non-monotonously generated by temporal inference, and resultant new knowledge is automatically inserted into relationship or hierarchical relationship.

Described below are the basic configurations on the part of the designer and on the part of the user according to the embodiment of the present invention.

On the part of the designer

(1) A code name is set in a super class.

(2) The function of editing a weighted UML is assigned.

(3) The function of processing weight relationship (three elements) is assigned (dependence, generalization, and relationship).

(4) The function of inferring multivalued logic of a variable is assigned (fuzzy logic and generic algorithm).

(5) The temporal inference function is assigned.

(6) The Web compiler function having outputs to an RDF schema (resource description framework schema), an XML schema, etc., is assigned.

On the part of the user

(1) A code name is a super class.

(2) The function of editing an UML is assigned.

(3) The function of processing weight relationship (three elements) is assigned (dependence, generalization, and relationship).

(4) The function of inferring multivalued logic of a variable is assigned (fuzzy logic or generic algorithm).

By providing the above-mentioned configuration, the following operations can be performed.

On the part of the designer

(1) All concepts can be represented in the knowledge structure having a super class at the top.

(2) The UML representing a designed knowledge structure can be edited.

(3) The relationship (three elements) of a knowledge structure can be processed using a weighting process.

(4) A weight can be inferred by multivalued logic (fuzzy logic, etc.).

(5) The above-mentioned multivalued logic can be obtained by the temporal inference in the process step in the sequence chart.

(6) A new class can be generated from an inference result.

(7) The above-mentioned result is Web-compiled based on the RDF schema or the XML schema.

On the part of the user

(1) Knowledge representation can be obtained by a knowledge structure having a super class at the top.

(2) A new class can be inferred based on several classes.

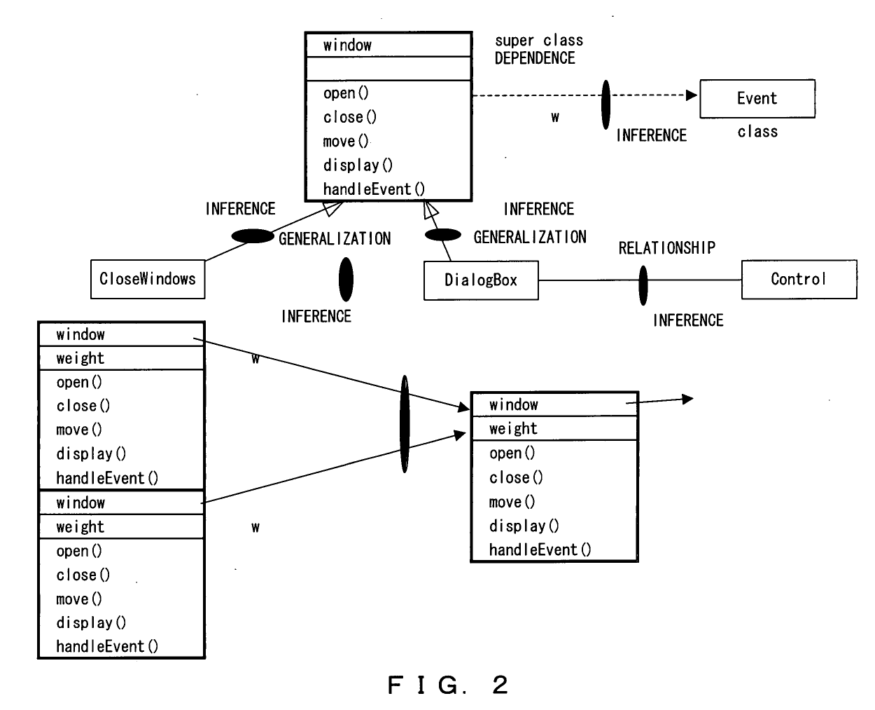

FIG. 2 shows the central portion of an embodiment of the present invention.

In FIG. 2, assume that a super class window is assigned. Based on the super class, inference is made using multivalued logic, thereby inferring and associating the relationship with other classes. In FIG. 2, the class CloseWindows is associated with a super class window based on the relationship of generalization. Additionally, the class DialogBox is associated with the super class window based on the relationship of generalization. Furthermore, the super class window is associated with the class Event, and the class DialogBox is associated with the class Control. The inference is also performed by multivalued logic on the relationship between CloseWindows and DialogBox. However, in the case shown in FIG. 2, no relationship is detected at all.

When association is made by multivalued logic, the weight of the relationship is computed, and the result is added to relationship data of the class. Furthermore, as a result of the inference by multivalued logic, a new class can be generated in the relationship among the classes even though the designer has not generated it. For example, when a class “notebook” and a class “tape recorder” are associated under the class “meeting” by a designer, a new class is generated as a result of generalization of “notebook” and “tape recorder” according to the concept of “record” which is a common feature of “notebook” and “tape recorder” by the inference using multivalued logic. When there is an instance “record” common to the instance of the class “notebook” and the instance of the class “tape recorder”, “notebook” and “tape recorder” can be structured by a broader concept “record” which belongs to a category of different viewpoint from “meeting” by generating the class of the name “record”. By automatically generating the structure from a plurality of viewpoints, the load of the designer can be reduced in the knowledge structuring operation.

On the part of the user shown in FIG. 2, a new class is generated if possible using the inference by multivalued logic based on the knowledge structure generated on the part of the designer. On the part of the user, the knowledge structure generated on the part of the designer can be used. However, by generating a new class, the structure can be systematically arranged, which helps understanding a knowledge structure generated on the part of the designer. Furthermore, using temporal inference, for example, in the case of a knowledge structure describing a step of developing a product, a sketch is available in the step of creating an idea, but no model or product exists, a sketch and a model are available in the step of realizing an idea, but no product exists, a sketch, a model, a design chart are available in the production step, but no product exists, and a sketch, a model, a design chart, and a product are all available in the final stage of the development. Thus, an available item is inferred with the passage of time. The temporal inference detects the classes of “idea creating step”, “idea realizing step”, “production step”, “final stage of the development”, etc., and the temporal inference is performed according to the information about each class.

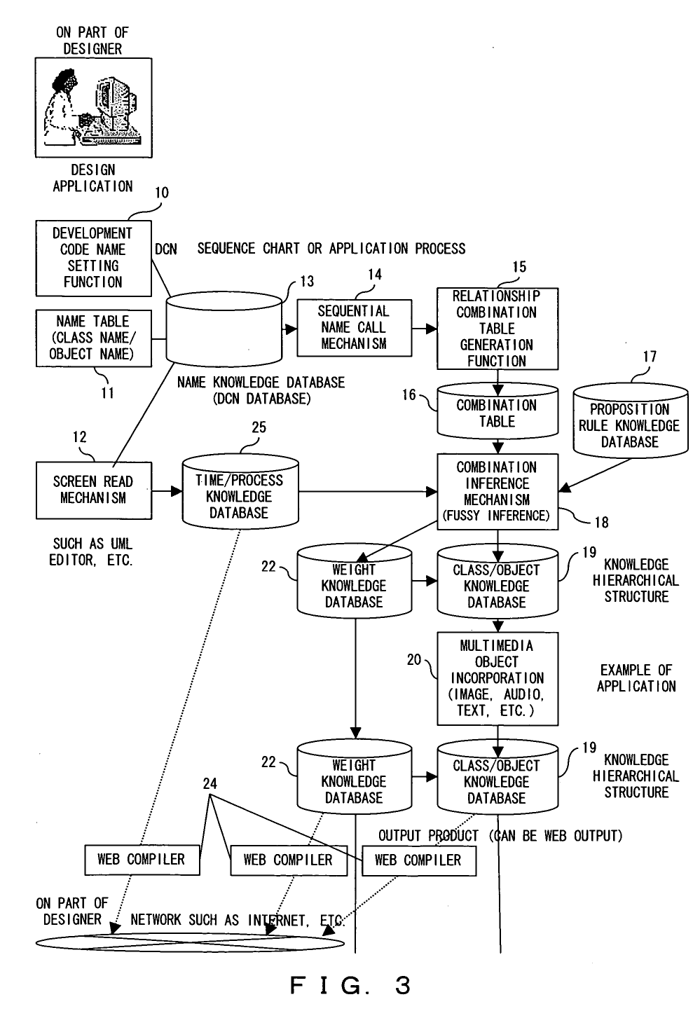

FIGS. 3 through 9 show examples in which an embodiment of the present invention is practically applied. In the application examples, the case in which a development code name (DCN) assigned when a device is developed is set as a super class, is described below.

The DCN is used when the name of a class/object, the property, and the title of the person are entered in a knowledge database through the Web on the part of the designer and on the part of the user, and the system used has a function by which the duplicate names are suppressed or a domain is set when duplication occurs. A development code name is positioned in a super class, under which a component class or a subclass is added as a cluster. The output when the combination of components is a functional behavior, is passed to an actual user on the Web. For example, a user can obtain knowledge in light of the user's personal viewpoint (implicit knowledge).

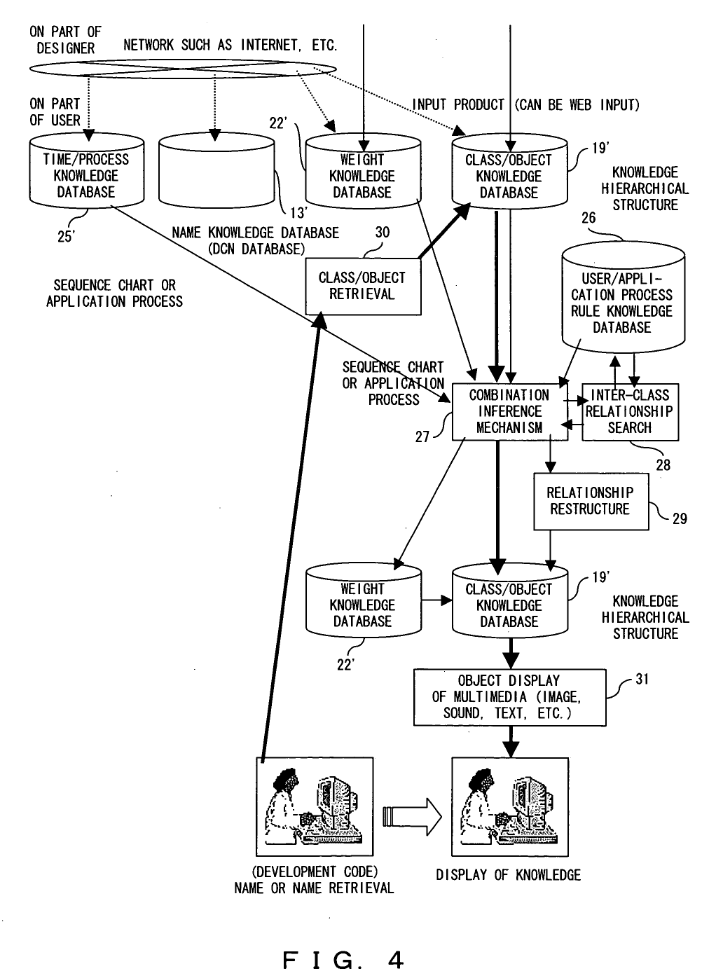

FIGS. 3 and 4 are block diagrams showing the entire flow.

On the part of the designer, a designing application includes a terminal formed by a development code name setting function 10, a name table 11 storing a class name and an object name, a screen read mechanism 12 such as UML editor, etc. Using them, a sequence chart and a view showing an application process are generated, and the class name, the object name, etc. are stored in a name knowledge database 13. The time and process contents of each class are stored from the screen read mechanism 12 in a time/process knowledge database 25.

A sequential name call mechanism 14 sequentially calls a class name and an object name from the name knowledge database 13, and performs relationship combination table generation 15. The relationship combination table is stored in a combination table 16.

In a combination inference mechanism 18, the time, process contents data, the relationship data between classes, and proposition rules are read from the time/process knowledge database 25, the combination table 16, and a proposition rule knowledge database 17, and inference such as fuzzy inference, inference according to a generic algorithm, etc. using multivalued logic is performed. As a result, the designed class and object are configured as a knowledge hierarchical structure, and the weight between classes or objects is computed. A class and an object included in the knowledge hierarchical structure are stored in a class/object knowledge database 19, and the weight is stored in a weight knowledge database 22.

The data of the time/process knowledge database 25 and the weight knowledge database 22, and the data obtained by processing in multimedia object incorporation 20 the object of the multimedia of the class/object knowledge database 19 are compiled for a Web display by a Web compiler 24, and provided as a output product on the part of the user over a network such as the Internet, etc. It is obvious that the output product need not be applied over a network. In this case, the output product is recorded on a storage medium such as DVD, etc., and the output product is passed to the user.

On the part of the user, a time/process knowledge database 25′, a name knowledge database 13′, a weight knowledge database 22′, and a class/object knowledge database 19′ are provided corresponding to the part of the designer, and the data from the part of the designer is stored as input product. The data of the time/process knowledge database 25′ and the data of the name knowledge database 13′ form a sequence chart, a view showing an application process, etc., are formed. The class/object having a knowledge hierarchical structure is stored in the class/object knowledge database 19′, and can be retrieved in class/object retrieval 30 by searching for a development code name and name retrieval.

Inference is made on the data in the time/process knowledge database 25′, the weight knowledge database 22′, and the class/object knowledge database 19′ by a combination inference mechanism 27′ using multivalued logic of a retrieved super class. In this case, the combination inference mechanism 27 can also perform an inter-class relationship search 28 through communications with a user/application process rule knowledge database 26. The combination inference mechanism 27 is an inference mechanism of multivalued logic using fuzzy logic, a neural network, a generic algorithm, etc., for inference of the relationship between classes, objects, etc. Thus, a relationship restructure 29 is performed between classes or objects obtained from the part of the designer, and a weight is stored in the weight knowledge database 22′, and a class or an object as a knowledge hierarchical structure is stored in the class/object knowledge database 19′. The user allows the knowledge structure restructured relating to a class, an object, and a super class retrieved by the development code name or in the name retrieval to be displayed on an object display 31. Thus, the knowledge information designed and structured on the part of the designer is displayed on the part of the user. The multimedia display includes a display of an image, and presentation of knowledge by audio and text.

Non-monotonous inference can be made using multivalued logic in the inference used in the embodiment according to the present invention. That is, two propositions can be stated as true when they are processed by proposition logic although they can be clearly recognized as false when a person reads or writes them. However, since a weight is output when multivalued logic is used, a proposition having a larger weight is practically recognized as true (non-monotonous) even though two propositions are true. As a result, inference of higher reliability and precision can be realized.

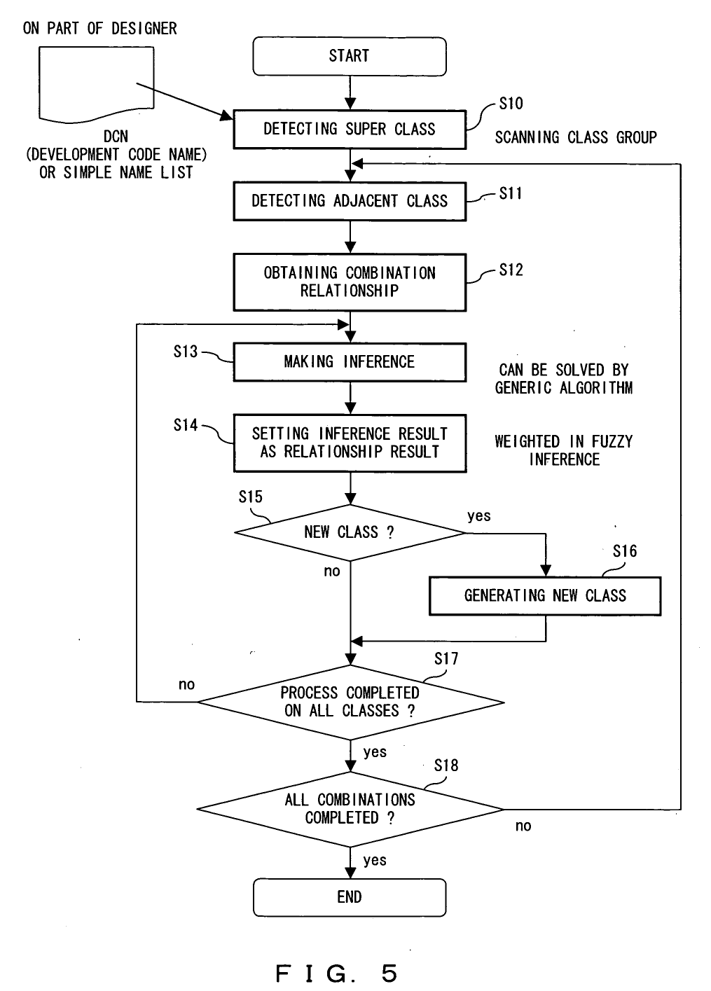

FIG. 5 shows a process flow on the part of the designer according to the embodiment of the present invention.

First, a development code name and a name list are input to a terminal on the part of the designer. In step S10, in response to the input, a class group is scanned, and a super class is detected. In step S11, an adjacent class associated with a super class is detected. In step S12, a combination relationship between classes is obtained. In step S13, inference is made using fuzzy logic, a neural network, a generic algorithm, etc. In step S14, a result of the inference is defined as a result of the relationship between classes. At this time, when fuzzy logic is used in the inference, each relationship is weighted.

In step S15, it is determined whether or not a new class is to be generated. If the determination result is YES in step S15, then a new class is generated in step S16, and control is passed to step S17. If the determination result is NO in step S15, then control is passed to step S17. In step S17, it is determined whether or not the process has been performed on all classes. If the determination result is NO in step S17, control is passed to step S13. If the determination result is YES in step S17, control is passed to step S18. It is determined in step S18 whether or not the process has been performed on all combinations. If the determination result is NO in step S18, control is returned to step S11. If the determination result is YES in step S18, the process terminates.

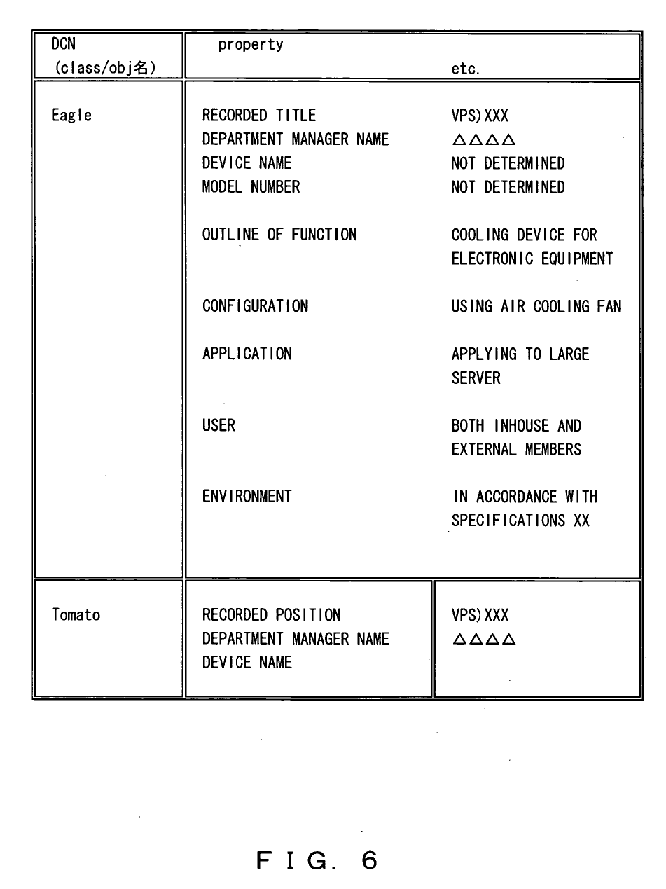

FIG. 6 shows an example of a development code name knowledge database.

In the database, the development code name DCN is stored as a class/object name, and a property is stored corresponding to the development code name. For the property, a recorded title, a division or department name, a device name, a model number, the outline of a function, a configuration, an application, a user, and an environment are recorded.

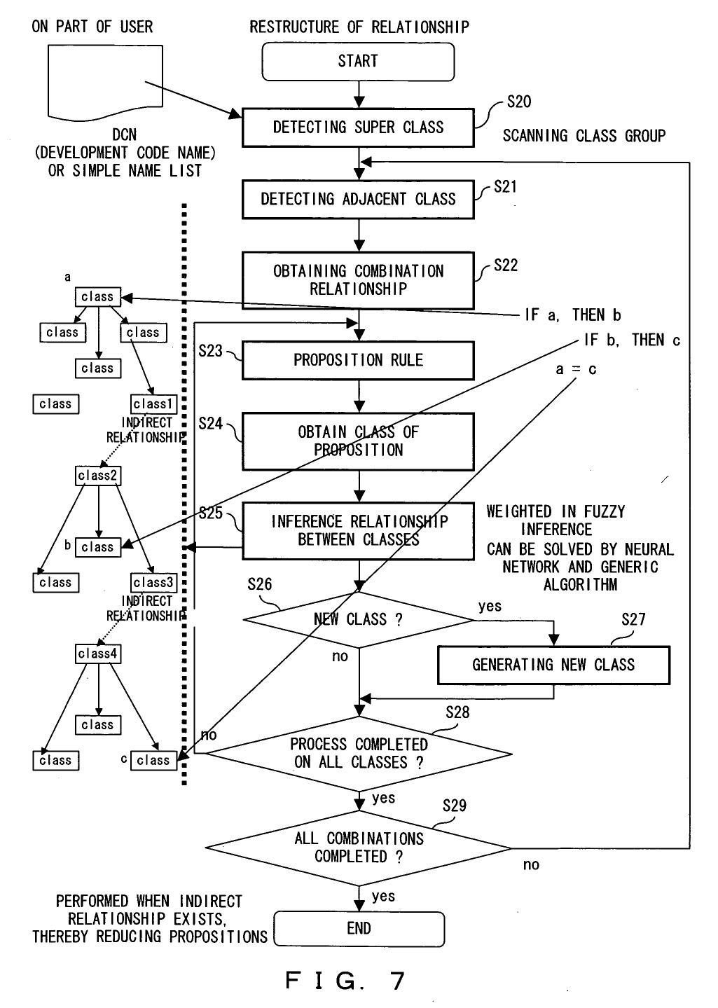

FIG. 7 shows the process flow on the part of the user according to the embodiment of the present invention.

On the part of the user, a development code name and a name list are input to the terminal of the user. In step S20, a class group is scanned, and a super class is detected. In step S21, a class adjacent to the super class is detected. In step S22, a combination relationship between classes is obtained. In step S23, a proposition rule is given to the terminal. In step S24, a class matching the proposition rule is obtained. The proposition rule describes, for example, a proposition that if “a”, then “b”, and if “b”, then “c”, and therefore if “a”, then “c”. According to the rule, in the relationship between the classes shown on the left of FIG. 6, if a class “a” is associated with the class 1, the class 1 is indirectly associated with the class 2, the class “b” is associated with the class 2, the class 3 associated with the class 2 is indirectly associated with the class 4, and the class 4 is associated with the class “c”, then the class “a” is indirectly associated with the class “c”. In step S25, the relationship between classes is inferred. The inference is made based on fuzzy logic, a neural network, and a generic algorithm. In step S26, it is determined whether or not a new class can be generated. If the determination result is YES, a new class is generated in step S27, and control is passed to step S28. If the determination result is NO, control is passed to step S28.

In step S28, it is determined whether or not the process has been performed on all classes. If the determination result is NO, control is passed to step S23. If the determination result is YES, control is passed to step S29. In step S29, it is determined whether or not the entire combining process has been completed. If the determination result is NO in step S29, control is returned to step S21. If the determination result is YES, the process terminates.

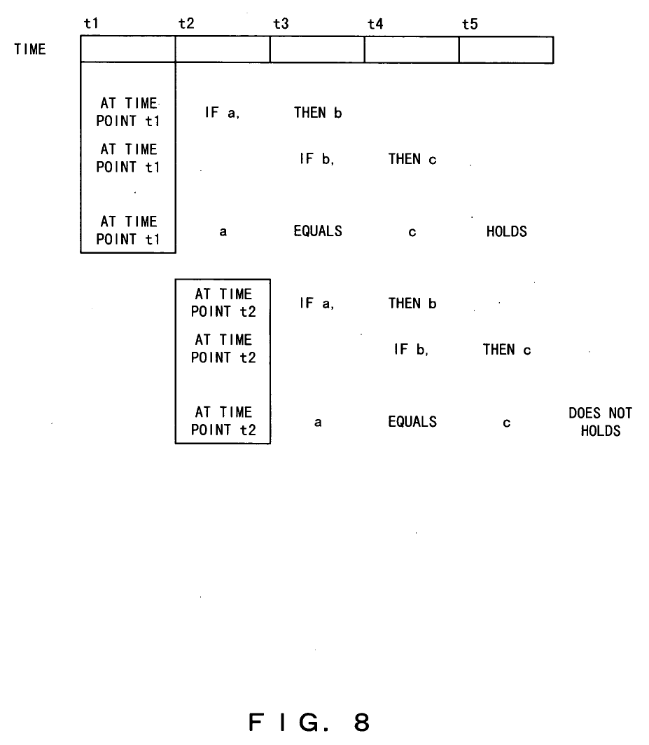

FIG. 8 is an explanatory view showing a temporal inference.

Based on the same inference rule, a result depends on the step of the current application process. Although if “a”, then “b”, and if “b”, then “c”, then “a” equals “c” at a time point t1, it does not hold at another time point t2.

Thus, an inference with the time taken into account can be made if the inference rule is prepared with the time considered.

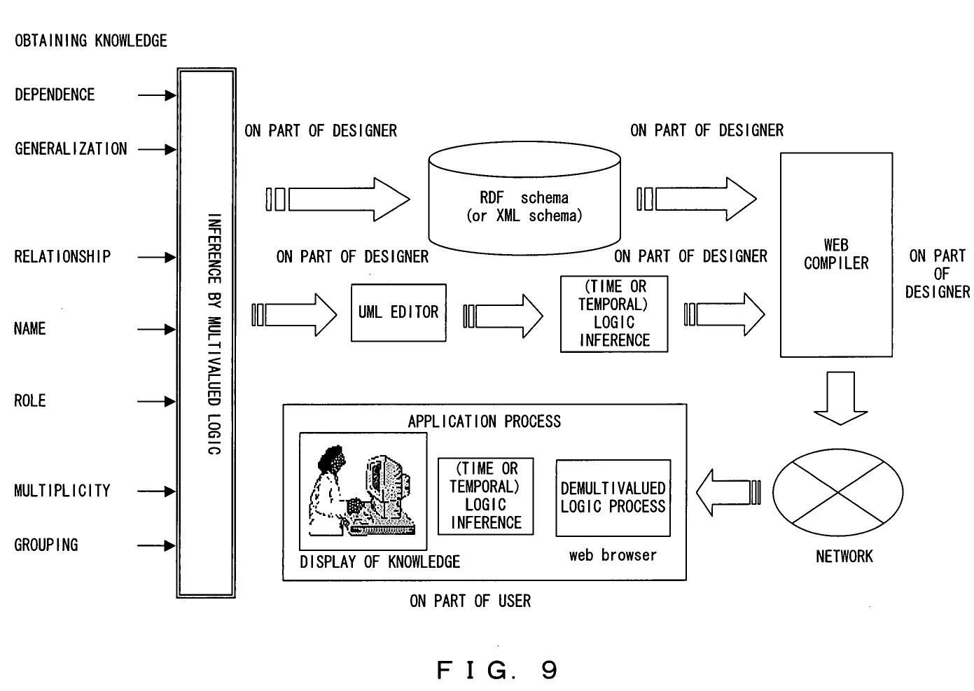

FIG. 9 is an explanatory view showing the case in which a knowledge structure obtained on the part of the designer is passed to the user as Web data.

On the part of the designer, a knowledge structure is input as the relationship (dependence, generalization, relationship, name, role, multiplicity, grouping) between classes, and a knowledge hierarchical structure is generated based on an inference by multivalued logic. On the part of the designer, it is Web-compiled using the RDF schema or the XML schema, and a temporal logic inference is made based on the inter-class relationship, it is then Web-compiled, and the data is published over a network. The user receives it over the network, performs a temporal inference and a demultivalued logic process, and allows the structured knowledge such as an application process, etc., on the terminal.

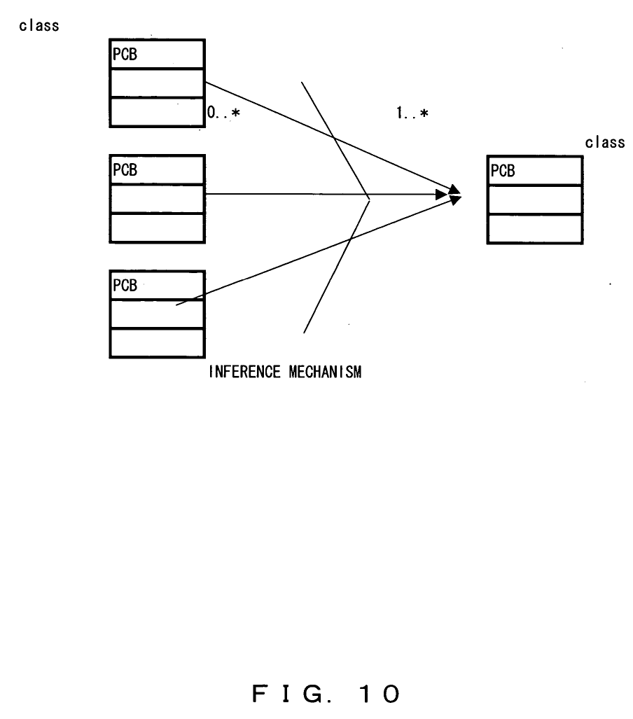

FIGS. 10 through 13 are explanatory views showing the relationship between a knowledge structure and a class.

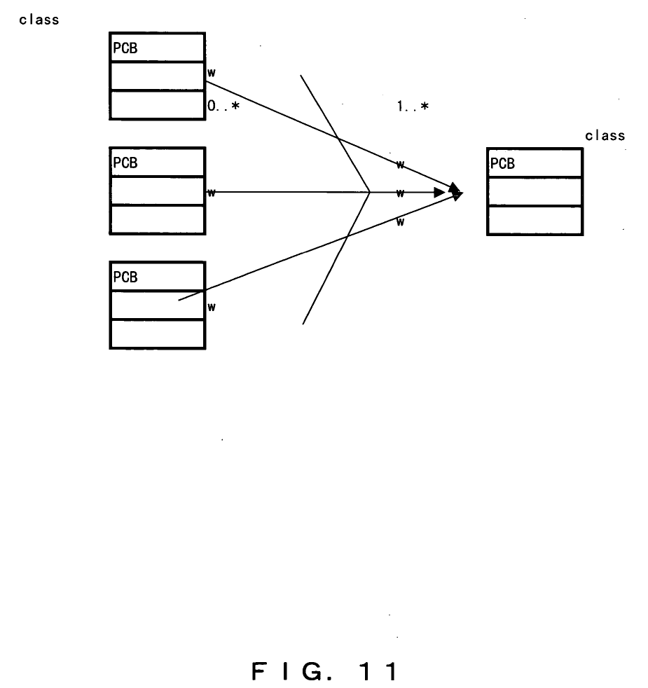

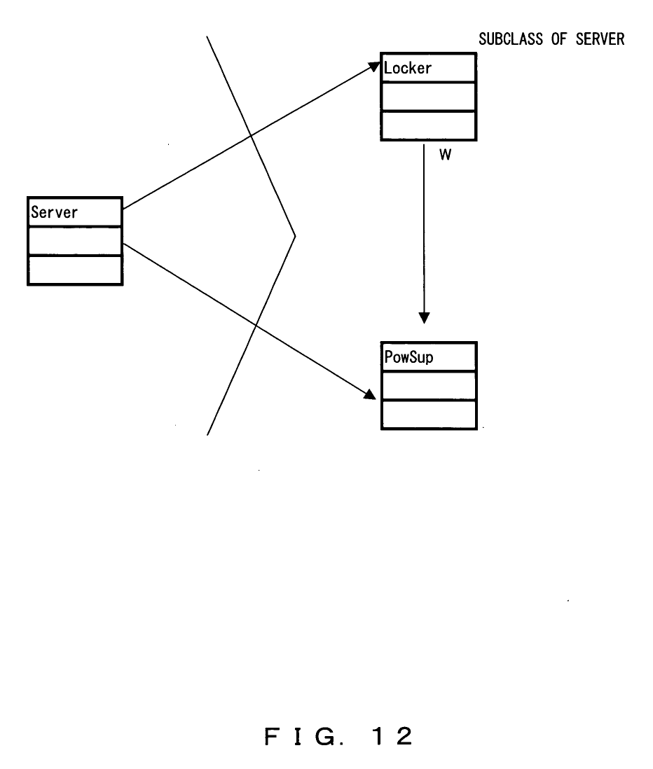

As shown in FIG. 10, when there are a plurality of classes having a common instance of “PCB”, a new class “PCB” is generated by an inference mechanism. Especially, according to the embodiment of the present invention, when fuzzy logic is used, a weight is added to each piece of related data from the original class to the newly generated class “PCB (refer to FIG. 11). In FIG. 12, when the class Server is associated with the class Locker, the relationship from Locker, which is the subclass of Server, to the class PowSup is generated with a weight based on the inference, and also according to the inference, the class PowSup is associated with the class Server. In this case, PowSup is defined as a subclass of Server.

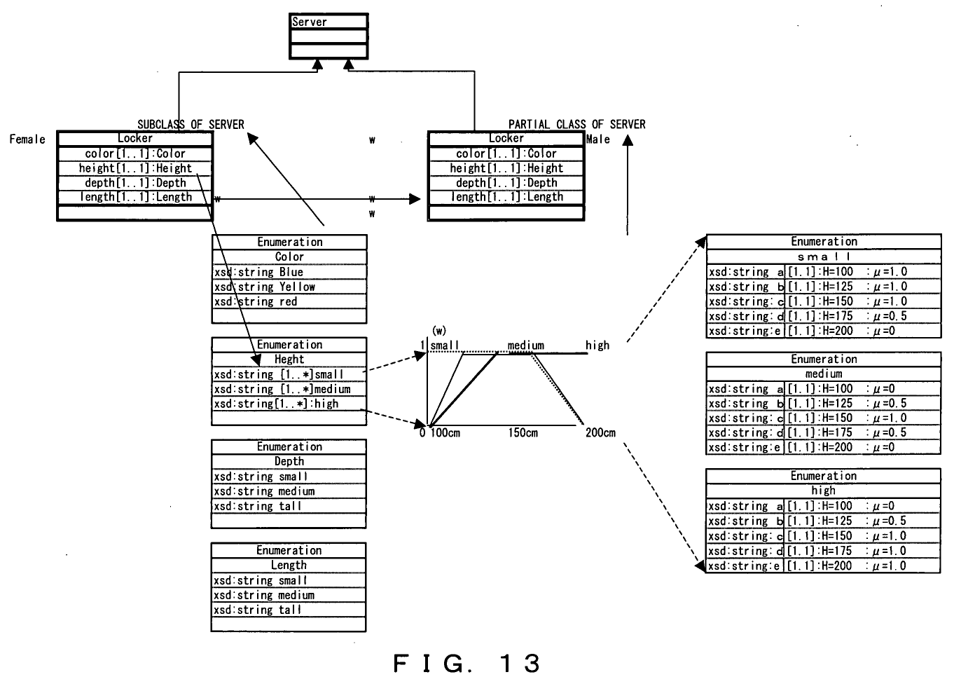

Furthermore, as shown in FIG. 13, the class Locker, which is a subclass of Server and describes the knowledge of a woman's locker, is assigned properties such as color, height, depth, length, etc., and they are assigned a value of instance to be recorded by the class Enumeration. Height is associated with another class Enumeration to prescribe the height information in detail.

Thus, by performing a multivalued inference process, a class which contains implicit knowledge on the part of the designer and has not been associated on the part of the designer can be associated, or a new class can be generated. Therefore, the implicit knowledge on the part of the designer can be described as accomplished knowledge in a class. The implicit knowledge which has become accomplished knowledge can be recognized on the part of the user. Therefore, the knowledge structure generated on the part of the designer can be passed to the user without distortion.

As described above, the present invention has the following effects.

(1) Implicit knowledge can be represented after incorporating it into the UML used in obtaining knowledge.

(2) Since a language can be used with a weight and multivalued logic visualized using UML, definite abstract knowledge can be incorporated without fail.

(3) Since the method of the present invention can be used for the specifications using UML, the contents of the specifications are simple and clear, but can be logically uncertain. Therefore, an uncertain factor in the real world can be obtained into knowledge.

(4) Since UML has been used for a concept model, a third party can describe knowledge in more detail although the concept itself contains a number of personal viewpoints of the party.

(5) The load on the part of the user can be reduced.

(6) A class and an object can be available without fail in a wide range as a result of the skilled designer performing an associating process which has conventionally been performed manually. For example, an appropriate object can be available when a guide book of a document, an image, and voice information is required when a product is faulty and a troubleshooting process is required.

What is claimed is:

1. A program used to direct a computer to use a knowledge processing method for use with a knowledge processing system formed by a structure of knowledge relating to a designed event based on a class and a relationship between classes, comprising:
storing in a database a super class having a name inclusively describing a class of the knowledge, the class, and the relationship between the classes; and
detecting a class relating to a super class stored in the database, generating a relationship between the classes by an inference based on multivalued logic, and configuring a knowledge structure from information stored in the database and the relationship between the classes obtained by the inference.

2. The program according to claim 1, wherein
the relationship between the classes includes a weight which weights a relationship between classes obtained by the inference based on the multivalued logic and a hierarchical structure.

3. The program according to claim 1, wherein
in the inferring step, a new class is generated when the new class can be generated to associate classes by the inference, and is associated with another class so that knowledge can be structured.

4. The program according to claim 1, wherein
in the inferring step, a temporal inference on a knowledge structure described in a class group is conducted and a relationship between classes with a change with time of described knowledge taken into account is included in the knowledge structure.

5. The program according to claim 1, wherein
on a part of a user who uses the knowledge structure generated on a part of a designer, a knowledge structure designed on the part of the designer is restructured by an inference using multivalued logic according to information about a super class describing the knowledge structure and a class group.

6. A knowledge processing method for use with a knowledge processing system formed by a structure of knowledge relating to a designed event based on a class and a relationship between classes, comprising:
storing in a database a super class having a name inclusively describing a class of the knowledge, the class, and the relationship between the classes; and
detecting a class relating to a super class stored in the database, generating a relationship between the classes by an inference based on multivalued logic, and configuring a knowledge structure from information stored in the database and the relationship between the classes obtained by the inference.

7. The method according to claim 6, wherein
the relationship between the classes includes a weight which weights a relationship between classes obtained by the inference based on the multivalued logic and a hierarchical structure.

8. The method according to claim 6, wherein
in the inferring step, a new class is generated when the new class can be generated to associate classes by the inference, and is associated with another class so that knowledge can be structured.

9. The method according to claim 6, wherein
in the inferring step, a temporal inference on a knowledge structure described in a class group is conducted and a relationship between classes with a change with time of described knowledge taken into account is included in the knowledge structure.

10. The method according to claim 6, wherein
on a part of a user who uses the knowledge structure generated on a part of a designer, a knowledge structure designed on the part of the designer is restructured by an inference using multivalued logic according to information about a super class describing the knowledge structure and a class group.

11. A knowledge processing system formed by a structure of knowledge relating to a designed event based on a class and a relationship between classes, comprising:
a storage unit storing in a database a super class having a name inclusively describing a class of the knowledge, the class, and the relationship between the classes; and
a inference unit detecting a class relating to a super class stored in the database, generating a relationship between the classes by a inference based on multivalued logic, and configuring a knowledge structure from information stored in the database and the relationship between the classes obtained by the inference.

12. The system according to claim 11, wherein
the relationship between the classes includes a weight which weights a relationship between classes obtained by the inference based on the multivalued logic and a hierarchical structure.

13. The system according to claim 11, wherein
in the inference unit, a new class is generated when the new class can be generated to associate classes by the inference, and is associated with another class so that knowledge can be structured.

14. The system according to claim 11, wherein
in the inference unit, a temporal inference on a knowledge structure described in a class group is conducted and a relationship between classes with a change with time of described knowledge taken into account is included in the knowledge structure.

15. The system according to claim 11, wherein
on a part of a user who uses the knowledge structure generated on a part of a designer, a knowledge structure designed on the part of the designer is restructured by an inference using multivalued logic according to information about a super class describing the knowledge structure and a class group.
